(19) United States
(12) Patent Application Publication
(10) Pub. No.: US 2006/0271944 A1
(43) Pub. Date: Nov. 30, 2006

(54) ELECTRONIC DEVICE WITH POSITIONING MECHANISM

(76) Inventors: He-Li Wang, Shenzhen (CN); Xiang-Hui Zhang, Shenzhen (CN); Wen-Jie Bao, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,368

(22) Filed: Dec. 26, 2005

(30) Foreign Application Priority Data
May 28, 2005 (CN) 200520059236.9

(51) Int. Cl. G11B 17/04

(52) U.S. Cl. 720/644; 720/655; 369/264; 369/79

(57) ABSTRACT

An electronic device includes a main body and a cover. The main body includes a back edge and defines a limiting slot at the back edge thereof. The main body forms a stop portion at the limiting slot. The cover is pivotally connected to the back edge of the main body. The cover includes a limiting member extending into the limiting slot. The limiting member including a peripheral surface is configured for cooperating with the stop portion to prevent the cover from over rotating.

### FIELD OF THE INVENTION

This invention relates to an electronic device and, more particularly, to an electronic device in a folding structure with a positioning mechanism.

### DESCRIPTION OF RELATED ART

Various electronic devices, such as disc players, personal digital assistants (PDAs), personal communication devices, are being widely used. In order to provide compact electronic devices, folding structures are often employed. An electronic device in a folding structure generally includes a main body, a cover, and a hinge assembly for rotatably connecting the main body and the cover.

For example, a conventional disc player includes a main body and a cover. A back edge of the cover is rotatably connected with the main body via a hinge assembly. A lock assembly is arranged at a front edge of the main body to selectively lock the cover with the main body. In order to prevent the cover from over rotating, a positioning mechanism is utilized. When the cover is rotated down, the lock assembly is engaged with the cover. When the lock assembly releases the cover, the cover pops up due to elasticity or manpower, and is stopped at an open position by the positioning mechanism. The positioning mechanism prevents the cover from over-rotating. In use, the disc player may frequently open or close. The positioning mechanism is thus frequently subject to impact forces. This requires the positioning mechanism to have a sufficient strong anti-impact capability, or the positioning mechanism is liable to wobble or even be damaged if not treated with care.

Therefore, a positioning mechanism for an electronic device with a strong structure is desired.

### SUMMARY OF INVENTION

An electronic device includes a main body and a cover. The main body includes a back edge and defines a limiting slot at the back edge thereof. The main body forms a stop portion at the limiting slot. The cover is pivotally connected to the back edge of the main body. The cover includes a limiting member extending into the limiting slot. The limiting member including a peripheral surface is configured for cooperating with the stop portion to prevent the cover from over rotating.

Other advantages and novel features will become more apparent from the following detailed description of preferred embodiments when taken in conjunction with the accompanying drawings, in which:

### BRIEF DESCRIPTION OF DRAWINGS

FIG. 1 is an isometric view of a disc player in accordance with an exemplary embodiment, the disc player including a main body and a cover;

FIG. 2 is an isometric view of the main body of the disc player of FIG. 1;

FIG. 3 is an isometric view of the cover of the disc player of FIG. 1;

FIG. 4 is an enlarged view of a circled portion IV of FIG. 1; and

FIG. 5 is an inverted, isometric view of the main body of FIG. 2.

### DETAILED DESCRIPTION

Electronic devices of this invention can be disc players, PDAs, cell phones, and other devices in a folding structure. In the following embodiments a disc player is used as an example for illustration.

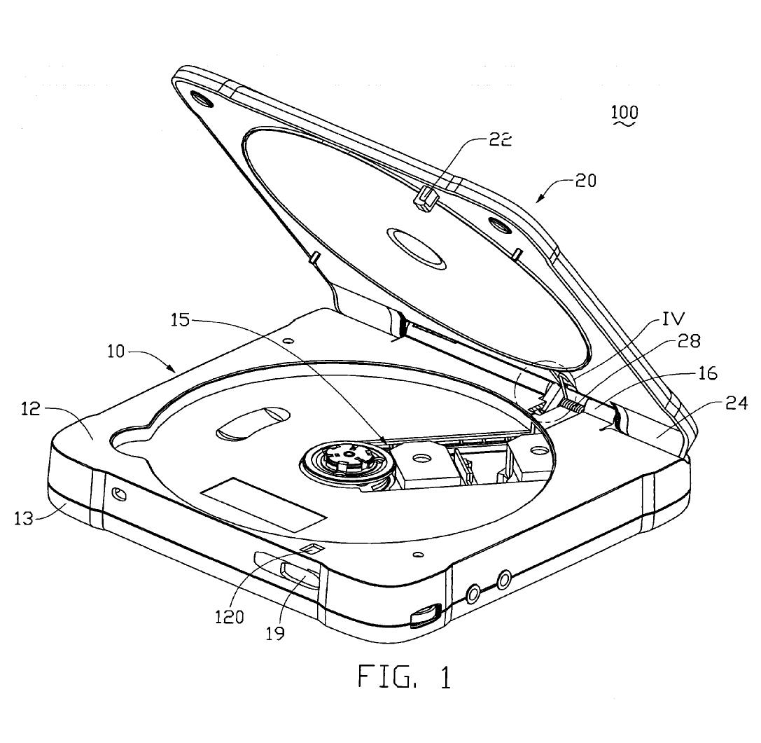

Referring to FIG. 1, a disc player 100 includes a main body 10, and a cover 20 pivotally connected with the main body 10.

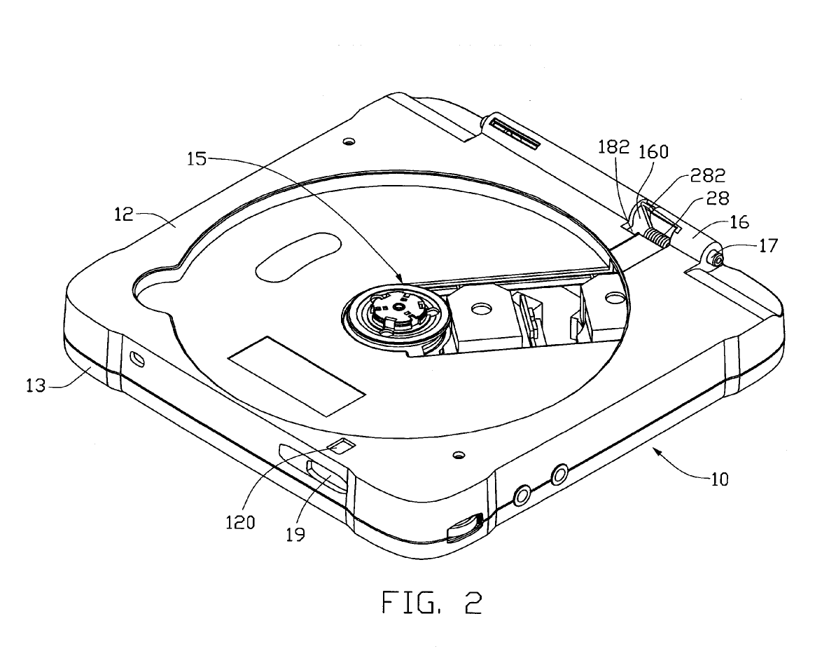

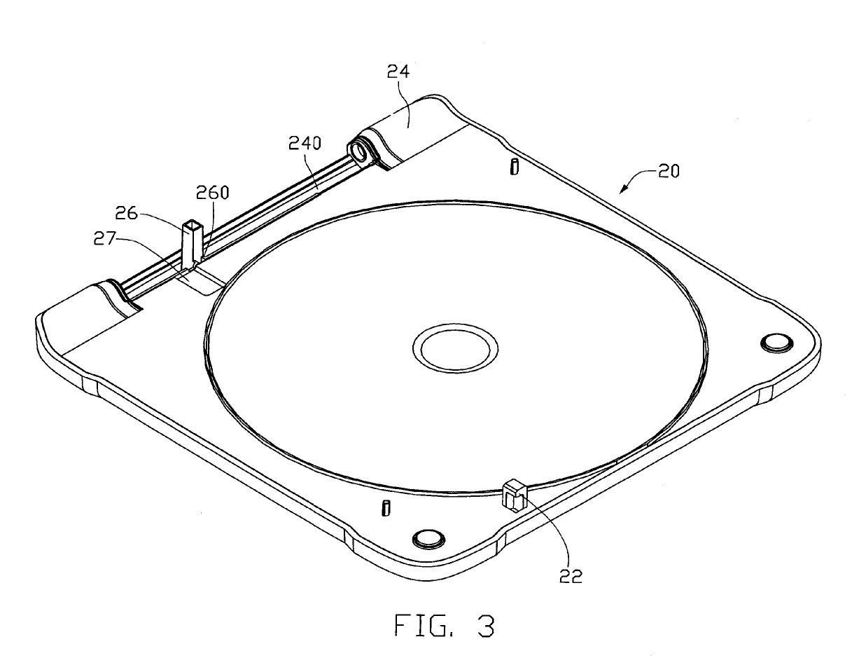

Referring also to FIG. 2, the main body 10 includes an upper body 12, a lower body 13 detachably connected with the upper body 12, and a traverse module 15 mounted between the upper body 12 and the lower body 13. The upper body 12 includes a top surface 122, and defines a hole 122 therein at a front corner of the top surface 122. Referring also to FIG. 3, the cover 20 forms a hook 22 at a front edge thereof. The hole 122 is for receiving the hook 22 when the cover 20 is closed to cover the main body 10.

A bearing bracket 16 is formed at a back edge of the upper body 12 of the main body 10. The bearing bracket 16 defines an opening 160 therein. A pair of shafts 17 is respectively secured to two opposite ends of the bearing bracket 16. A lock assembly 19 is mounted between the upper body 12 and the lower body 13 for selectively engaging with the hook 22, to maintain the cover 20 in the closed position.

A pair of sleeves 24 is formed at two opposite ends of a back edge of the cover 20. The pair of sleeves 24 defines an accommodating area 240 therebetween for receiving the bearing bracket 16. An elongated limiting member 26 is formed near the accommodating area 240 and extends downwardly from the cover 20. In this embodiment, the limiting member 26 is substantially a hollow polyhedron. Alternatively, the limiting member 26 may be configured to be solid. A pair of ribs 260 is formed near an upper end (not labeled) of the limiting member 26 and extends to the back edge of the cover 20. Therefore, the ribs 260 connect between the upper end of the limiting member 26 and the cover 20. The ribs 260 are utilized to firmly fix the limiting member 26 with the cover 20. A recess 27 is defined at the back edge of the cover 20.

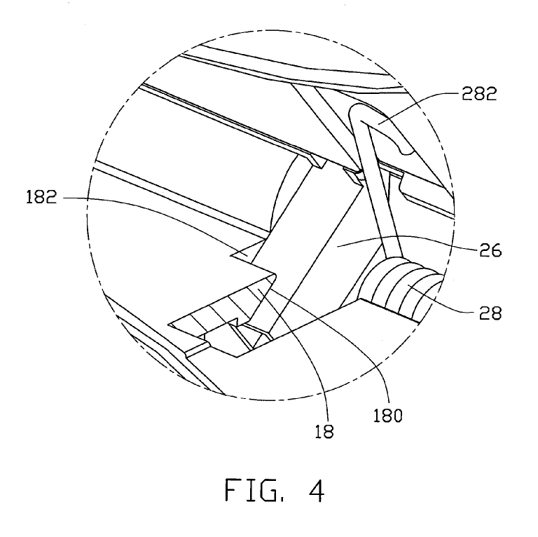

Referring also to FIG. 4, a limiting slot 182 is defined at the back edge of the upper body 12. A stop portion 18 is formed near a side edge of the limiting slot 182. The stop portion 18 has a flat stop surface 180 inclined to the top surface 120 of the main body 10. The flat stop surface 180 extends downwardly at a sharp angle from the top surface 120 of the upper body 12 to a bottom surface (not labeled) of the upper body 12. The flat stop surface 180 cooperates with a flat peripheral surface of the limiting member 26, preventing the cover 20 from over rotating.

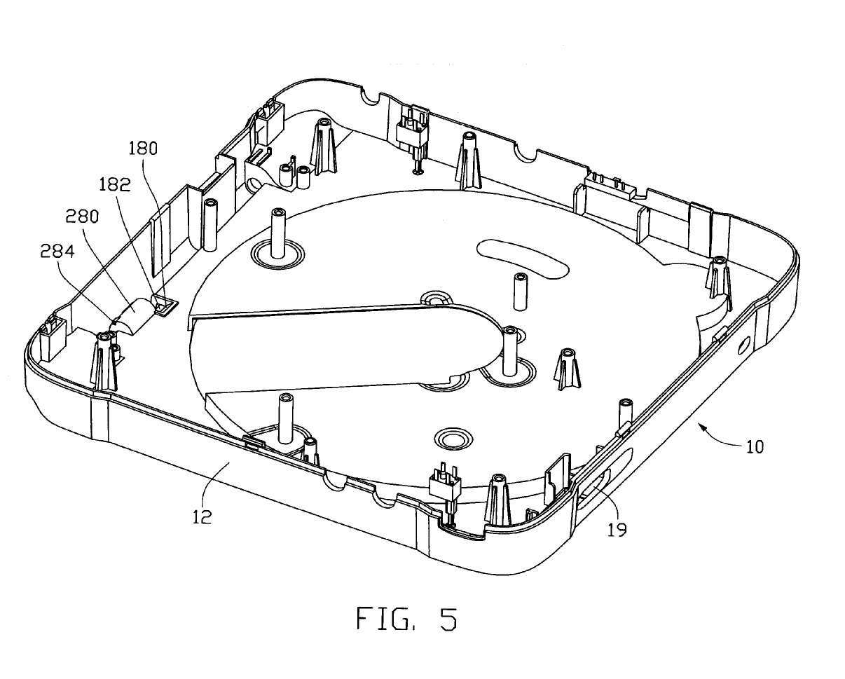

Referring also to FIG. 5, the upper body 12 defines a spring accommodating portion 280 for receiving a torsion spring 28. The torsion spring 28 includes a first end 282 and a second end 284. The first end 282 of the torsion spring 28 extends out from the opening 160 of the bearing bracket 16 and is moveably received by the recess 27. The second end 284 of the torsion spring 28 is fixed at a sidewall of the spring accommodating portion 280.

In assembly, the torsion spring 28 is placed in the spring accommodating portion 280 through the opening 160, with the second end 284 being fixed at the sidewall of the spring accommodating portion 280. Next, the cover 20 is pivotally connected with the main body 10, with the shafts 17 being inserted into the sleeves 24. Meanwhile, the limiting member 26 is inserted into the limiting slot 182. The first end 282 of the torsion spring 28 is moveably received in the recess 27.

When the cover 20 is rotated down to a closed position, the hook 22 is inserted into the hole 122 and firmly engaged by the lock assembly 19. Meanwhile, the torsion spring 28 is compressed. When the lock assembly 19 is caused to release the hook 22, the torsion spring 28 is released. The cover 20 pops up due to the elasticity of the torsion spring 28. Then the limiting member 26 impacts the flat stop surface 180 of the stop portion 18 and is stopped, the cover 20 stops rotating and is in an open position.

Because the area of contact between the limiting member 26 and the stop portion 18 is relatively large, the force of the impact of the limiting member 26 against the stop portion 18 is weakened. Further, the ribs 260 are provided for firmly fixing the limiting member 26 at the cover 20. The limiting member 26 is thus avoided to wobble or to be damaged.

It should be noted that the limiting member 26 could alternatively be a hollow or solid cylinder, or other similar block. In that instance, the flat stop surface 180 of the stop portion 18 is configured in a shape corresponding to the limiting member 26. In addition, the number of ribs 260 is not limited to the above-described exemplary embodiments.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. An electronic device, comprising:
a main body comprising a back edge, defining a limiting slot at the back edge thereof, and forming a stop portion at the limiting slot; and
a cover pivotally connected to the back edge of the main body, comprising a limiting member extending into the limiting slot, the limiting member comprising a peripheral surface being configured for cooperating with the stop portion to prevent the cover from over rotating.

2. The electronic device as claimed in claim 1, wherein the peripheral surface of the limiting member is flat, and the stop portion comprising a flat stop surface for cooperating with the peripheral surface.

3. The electronic device as claimed in claim 2, wherein the main body comprising a top surface, the stop surface is inclined to a top surface of the main body.

4. The electronic device as claimed in claim 1, wherein the shape of the limiting member is one of a polyhedron and a cylinder.

5. The electronic device as claimed in claim 1, wherein the main body comprises an elastic element, the elastic element having a first end and a second end, the first end being fixed with the main body, the second end being coupled to the cover.

6. The electronic device as claimed in claim 1, wherein the main body comprises a bearing bracket formed at the back edge thereof, a pair of shafts being respectively secured at two opposite ends of the bearing bracket, and the cover forms a pair of sleeves formed at a back edge of the cover for pivotally engaging with the shafts.

7. The electronic device as claimed in claim 6, wherein the bearing bracket defines an opening corresponding to the elastic element, the limiting slot communicating with the opening.

8. The electronic device as claimed in claim 1, wherein the limiting member is one of a hollow member and a solid member.

9. An electronic device comprising:
a main body defining a limiting slot therein, and forming a stop surface at the limiting slot, the stop surface being inclined to a top surface of the main body; and
a cover attached to the main body and pivotable between a closed position and an open position, the cover comprising a limiting member extending into the limiting slot, the limiting member cooperating with the stop surface to prevent the cover from over rotating when the cover is pivoted to the open position.

10. The electronic device as claimed in claim 9, wherein the limiting member is one of a solid member and a hollow member.

11. The electronic device as claimed in claim 9, wherein the limiting member is elongated.

12. The electronic device as claimed in claim 11, wherein the limiting member is one of a polyhedron and a cylinder.

13. The electronic device as claimed in claim 9, wherein the limiting member comprises a peripheral surface for cooperating with the stop surface of the main body.

14. The electronic device as claimed in claim 13, wherein the stop surface and the peripheral surface are both flat.

15. The electronic device as claimed in claim 9, wherein the main body comprises an upper body and a lower body coupled together, the stop surface extends from a top surface of the upper body to a bottom surface of the upper body.

16. The electronic device as claimed in claim 9, wherein a rib is connected between the limiting member and the cover to enhance the strength of the limiting member.

17. An electronic device in a folding structure, comprising:
a main body defining a limiting slot therein; and
a cover attached to the main body and pivotable between a closed position and an open position, the cover comprising a limiting member extending into the limiting slot, the limiting member being engaged with an edge of the main body at the limiting slot when the cover is pivoted to the open position, the limiting member disengaging from the edge when the cover is pivoted away from the open position.

18. The electronic device as claimed in claim 17, wherein the limiting member is elongated.

19. The electronic device as claimed in claim 17, wherein the limiting member comprises a flat surface, the main body comprises a flat stop surface at the edge to cooperate with the flat surface of the limiting member to prevent the cover from over rotating, and the stop surface is inclined to a top surface of the main body.

20. The electronic device as claimed in claim 19, wherein the stop surface extends downwardly from the top surface of the main body.
